(19) United States
(12) Patent Application Publication
(10) Pub. No.: US 2003/0002784 A1
(43) Pub. Date: Jan. 2, 2003

(54) Optical bandpass filter for wavelength division multiplexing

(76) Inventor: Masataka Shirasaki, Winchester, MA (US)

Correspondence Address: Dr. Masataka Shirasaki, CTO, 47361 Bayside Parkway, Fremont, CA, 94538, US

(21) Appl. No.: 09/891,112

(22) Filed: Jun. 25, 2001

(51) Int. Cl. G02B 6/293; H04J 14/02

(52) U.S. Cl. 385/24; 359/127

(57) ABSTRACT

The invention relates to an optical bandpass filter and a method for filtering an optical signal having a plurality of WDM component wavelengths. The optical bandpass filter includes a spectrally dispersive element and an optical module. The spectrally dispersive element is adapted to receive the optical signal and to provide a dispersed optical signal to the optical module. The optical module returns predetermined WDM component wavelengths to the spectrally dispersive element. The predetermined WDM component wavelengths are imaged to predetermined locations.

### FIELD OF THE INVENTION

This invention relates generally to optical devices, and more specifically to optical bandpass filters suitable for use in optical communication systems.

### BACKGROUND OF THE INVENTION

The demand for increased communication data rates necessitates a constant need for improved technologies to support that demand. One such emerging technology area is in fiber-optic communications, in which data is transmitted as light energy over optical fibers. To increase data rates, multiple data channels are provided on a single optical fiber link. For example, in wavelength division multiplexing (WDM), the channels in a single fiber are differentiated by wavelength. This differentiation requires special optical components to combine or separate the channels for transmission, switching and detection. One such component is used to separate light of distinct wavelength bands. The spectral response for each channel in an ideal channel separator is 1.00 within the passband and zero outside the passband. Thus, in an ideal channel separator the separation between channels is distinct such that there is no crosstalk between the separated channels (i.e., light energy in a channel within the passband and light energy in a channel outside of the passband are not coupled to each other).

One type of channel separator is an interference filter. Interference filters consist of a multilayered filmstack and operate as follows. WDM light energy is incident on the multilayered film filter. The filter is designed so that it reflects light energy having certain wavelengths and transmits light energy having other wavelengths. Conventional interference filters have significant problems. In order to realize sharp spectral definition and minimal crosstalk, the interference filter can include more than one hundred layers. Consequently, the cost to manufacture these multilayered film filters is relatively high. Also, future WDM systems having narrower channel spacing will require higher performance than currently possible using conventional interference filter technology.

What is needed is an optical bandpass filter which is relatively inexpensive and provides high performance for current and future filtering applications.

### SUMMARY OF THE INVENTION

In one embodiment, the invention relates to a bandpass filter for filtering an optical signal having a plurality of WDM component wavelengths. The bandpass filter includes a spectrally dispersive element to provide a dispersed optical signal having a plurality of WDM component wavelengths. In addition, the bandpass filter includes an optical module. The optical module includes an entrance port, a light concentration plane, and an exit port. The index normalized distance between the entrance port and the light concentration plane is equivalent to the index normalized distance between the exit port and the light concentration plane. The optical module directs predetermined WDM component wavelengths through the spectrally dispersive element to a predetermined location.

In another embodiment, the optical module includes a first and second reflective surface. In yet another embodiment, the first reflective surface corresponds to the light concentration plane of the optical module. In still another embodiment, the bandpass filter includes more than one optical module. Alternatively, the optical module is a prism. The optical module also includes an optical delay element between the light concentration plane and the exit port.

In a further embodiment, the bandpass filter includes an input waveguide for providing an optical signal and at least one output waveguide for receiving the optical signal. Additionally, the bandpass filter includes an optical lens for collimating the optical signal and an optical lens for imaging the optical signal. In alternative embodiments, the spectrally dispersive element is a transmission or reflection type diffraction grating.

One illustrative bandpass filter includes an input waveguide for providing an optical signal, a first optical element for collimating the optical signal, and a grating for dispersing the optical signal according to wavelength. The bandpass filter further includes a second optical element for imaging wavelength components of the dispersed optical signal onto a first reflection surface of a prism. The prism reflects the image back through the second optical element to the grating. The grating then directs the wavelength components through the first optical element to an output waveguide. Alternative embodiments include multiple prisms and multiple output waveguides. The illustrative embodiment also includes an optical delay element in optical communication with the prism.

The invention is also embodied in a method of filtering an optical signal. The method includes spatially dispersing the optical signal to generate a dispersed optical signal having a plurality of WDM component wavelengths. The method also includes reflecting the WDM component wavelengths to a predetermined location such that an index normalized distance between a source of the optical signal and a light concentration plane of an optical module is equivalent to an index normalized distance between the predetermined location and the light concentration plane. In the illustrative embodiment, the light concentration plane coincides with a first reflective surface of the optical module.

Alternatively, the method also includes collimating the optical signal prior to dispersing the optical signal. The method also includes imaging WDM component wavelengths of the dispersed optical signal. Additionally, the method includes receiving the WDM component wavelengths at the predetermined location.

### BRIEF DESCRIPTION OF THE DRAWINGS

The above and further advantages of the invention may be better understood by referring to the following description taken in conjunction with the accompanying drawings, in which:

FIG. 1 is a block diagram of an embodiment of an optical bandpass filter according to the invention;

FIG. 2 is a perspective view of an embodiment of an optical bandpass filter showing an illustrative optical module according to the invention;

FIG. 3 is a block diagram of the illustrative optical module of FIG. 2;

FIG. 4 is a graphical representation of the transmission band of the illustrative optical bandpass filter of FIG. 2;

FIG. 5A-FIG. 5C are block diagrams of various embodiments of optical modules according to the invention;

FIG. 6A-FIG. 6C are block diagrams of embodiments of spectrally dispersive elements according to the invention;

FIG. 7A & 7B are a perspective view of the illustrative optical module of FIG. 2 and its corresponding passband response;

FIG. 8 is a block diagram of an embodiment of an optical bandpass filter according to the invention;

FIG. 9 is a perspective view of illustrative optical modules of FIG. 8;

FIG. 10 is a graphical representation of the transmission bands of the optical bandpass filter of FIG. 8;

FIG. 11 is a perspective view of an embodiment of an optical bandpass filter according to the invention;

FIG. 12 is a block diagram of an embodiment of an optical bandpass filter according to the invention;

FIG. 13A & FIG. 13B are block diagrams of other embodiments of optical bandpass filters according to the invention; and

FIG. 14 is a flowchart representation of an embodiment of a method of bandpass filtering an optical signal according to the invention.

### DETAILED DESCRIPTION

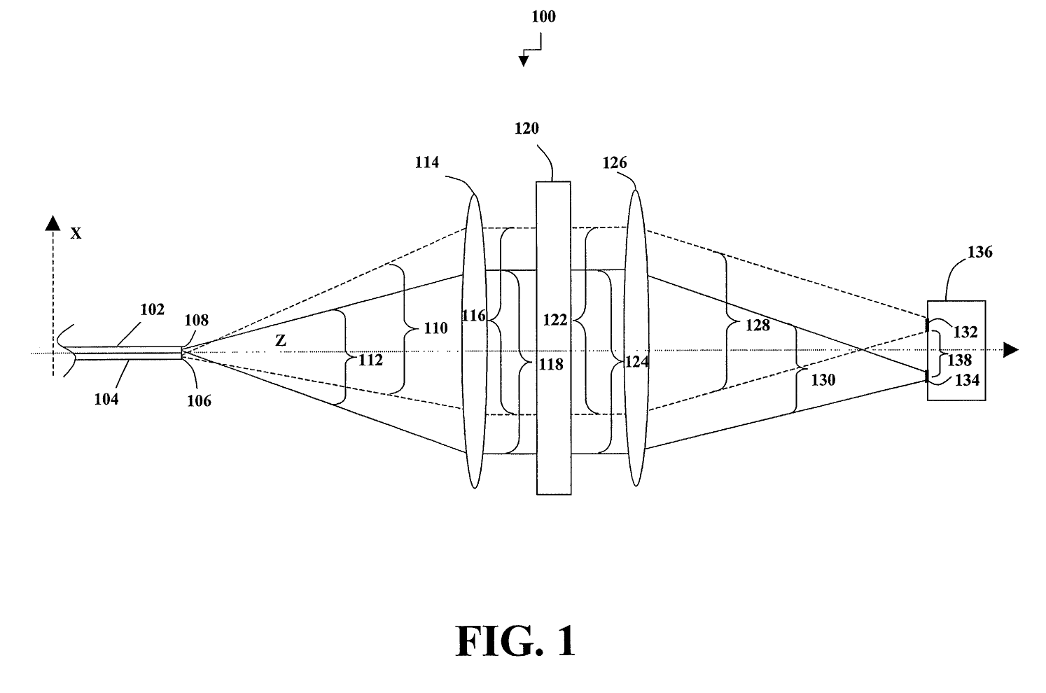

FIG. 1 is a block diagram of an optical bandpass filter 100 according to one embodiment of the invention. An optical source (not shown) provides an optical signal 112 which passes through an input waveguide 102 (e., an optical fiber). One embodiment of the optical bandpass filter 100 includes an optical element 114 (e.g., a lens) adapted to collimate the optical signal 112 into a collimated beam 118. Although a lens is depicted as the optical element 114 in FIG. 1, other optical elements can be used to collimate the optical signal 112 without departing from the scope of the invention. The focal length of the optical element 114 is equal to the distance between the optical element 114 and the endface 108 of the input waveguide 102.

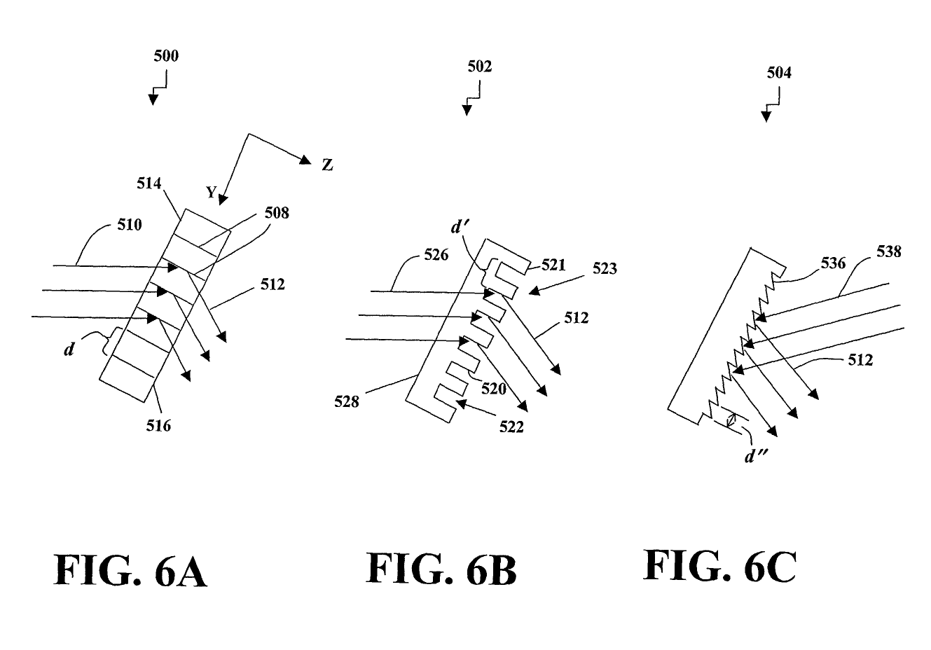

A spectrally dispersive element 120 is positioned to receive the collimated optical signal 118. The spectrally dispersive element 120 generates a dispersed optical signal having a plurality of WDM component wavelength signals (only one shown) 124 of different wavelengths along the direction normal to the plane of the figure. In one embodiment, the spectrally dispersive element 120 is a diffraction grating. In further embodiments, the optical grating is a transmission grating or a reflection grating. Skilled artisans will appreciate that any element or module that spectrally disperses an optical signal having a plurality of WDM component wavelengths can be substituted for the spectrally dispersive element 120 without departing from the scope of the invention. Illustrative embodiments of the spectrally dispersive element 120 are discussed in more detail with reference to FIGS. 6A through 6C.

An optical element 126 receives the plurality of WDM component wavelength signals 124 from the spectrally dispersive element 120. The optical element 126 (e.g., a lens) images each of the plurality of WDM component wavelength signals 124 along a focal line (not shown) through an entrance port 134 in the optical module 136 where the focal line is normal to the plane of the figure.

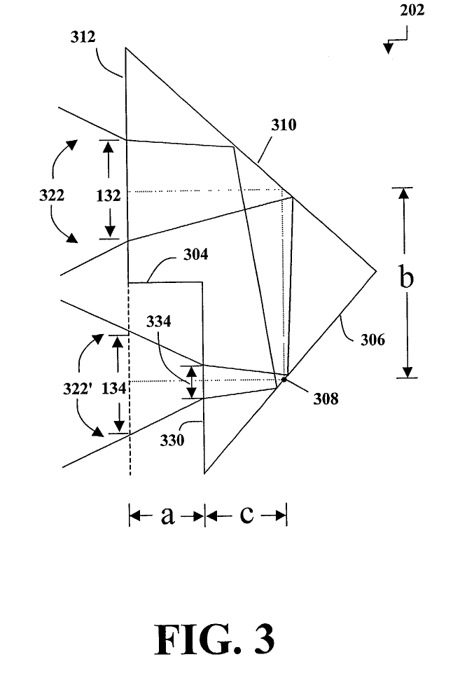

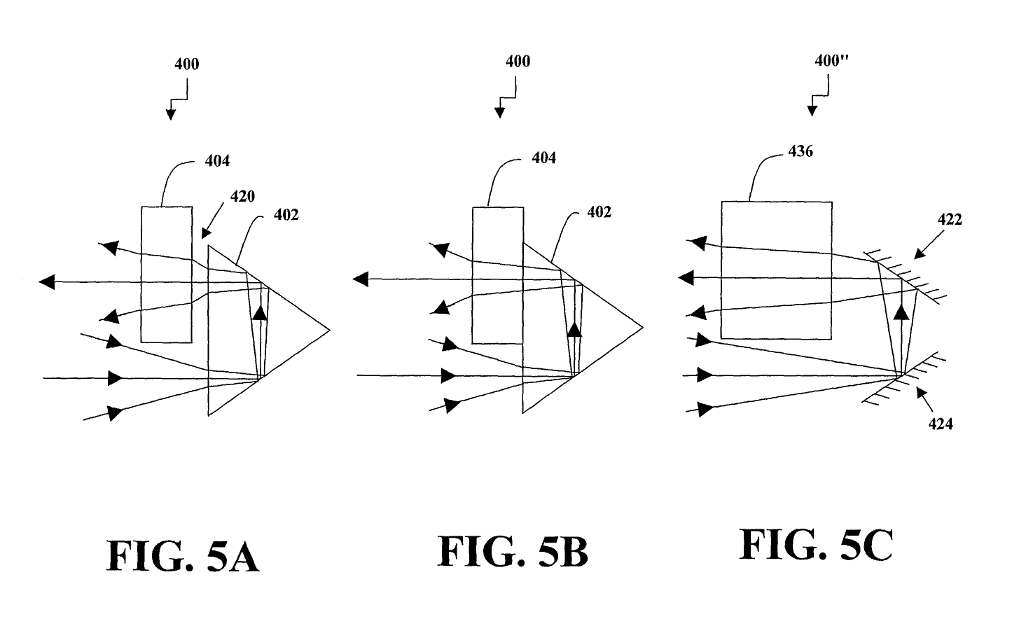

While WDM component wavelengths outside of the passband do not enter the optical module 136, WDM component wavelengths 130 within the passband are imaged onto a light concentration plane (not shown) within the optical module 136. The optical module 136 can include one or more optical elements. Alternative illustrative embodiments of the optical module 136 are discussed in more detail with reference to FIG. 3 and FIGS. 5A through 5C.

After the WDM component wavelengths 130 are imaged onto the light concentration plane, they become the WDM component wavelengths 128 and exit the optical module 136 through the exit port 132 as a diverging beam. The function of the optical module 136 is to return the WDM component wavelength signals within the passband through the path displaced by a distance. The optical element 126 collimates the WDM component wavelengths 128. Spectrally dispersive element 120 directs each of the plurality of WDM component wavelengths 116 to the optical element 114. The optical element 114 images the WDM component wavelengths 116 within the passband of the optical filter 100 onto the endface 106 of an output waveguide 104. One important aspect of the optical module 136 is that an index normalized distance between the entrance port 134 and the light concentration plane is substantially equivalent to an index normalized distance between the light concentration plane and an exit port 132 of the optical module 136 in order to couple the light into an output waveguide 104. The index normalized distance is defined as the physical separation between two locations divided by the index of refraction of the intervening material. Because the exit port 132 is displaced by a distance 138 relative to the entrance port 134 of the optical module 136, the endface 106 of the output waveguide 104 is also displaced by a corresponding distance from the endface 108 of the input waveguide 102 along the X-direction.

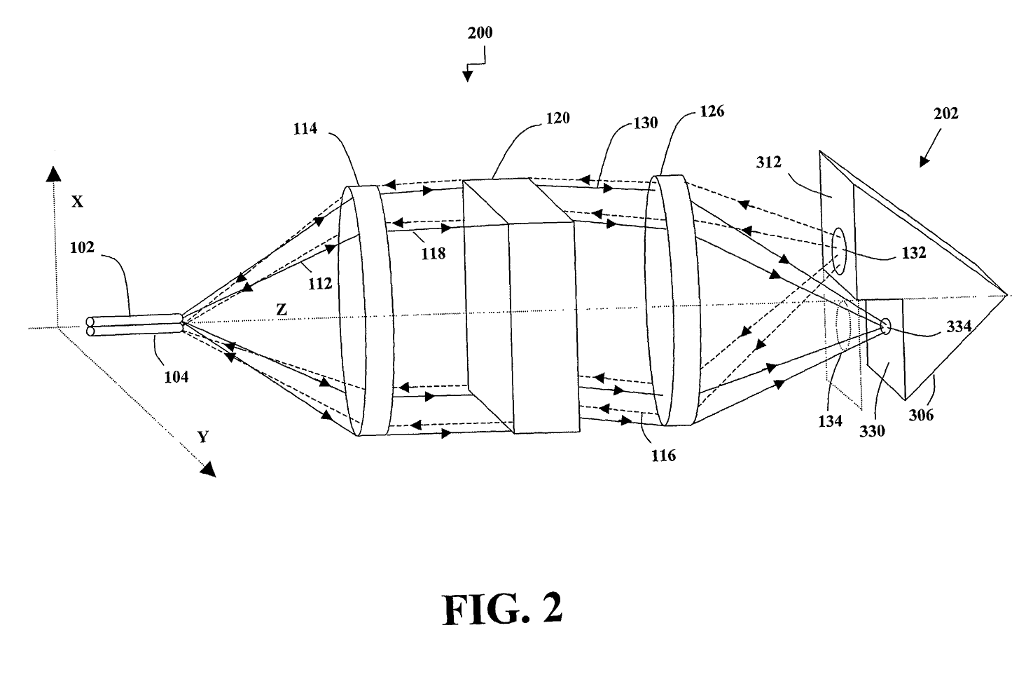

FIG. 2 is a perspective view of an illustrative embodiment of the optical bandpass filter 200 according to the present invention. In this embodiment, the optical module 136 is a prism reflector 202. The filter 200 also includes the input waveguide 102 for providing an optical signal 112 having a plurality of WDM component wavelengths to the optical element 114. Optical element 114 collimates the optical signal 112. Spectrally dispersive element 120 disperses the collimated optical signal 118 into its WDM component wavelengths. Each WDM component wavelength has a unique angular orientation in the Z-Y plane with respect to the Z-axis. One WDM component wavelength 130 is shown for clarity. The dispersion occurs substantially in the Y-axis as depicted in FIG. 2. Only predetermined WDM component wavelengths 130 are incident on the surface 330 of the prism reflector 202 and focused onto the first reflective surface 306 of the prism reflector 202. WDM component wavelengths that are not focused onto the first reflective surface 306 are excluded from the passband of the filter 200. In one embodiment, the prism reflector 202 includes two surfaces which provide total internal reflection. The predetermined WDM component wavelengths 130 are returned through the exit surface 312 to the optical element 126 and collimated. Spectrally dispersive element 120 directs the predetermined WDM component wavelengths 116 to the optical element 114. Light exiting the port 132 is displaced in the X-axis such that it is received at the output waveguide 104. The position of the exit port 132 defines the placement of the output fiber 104 in the X-axis.

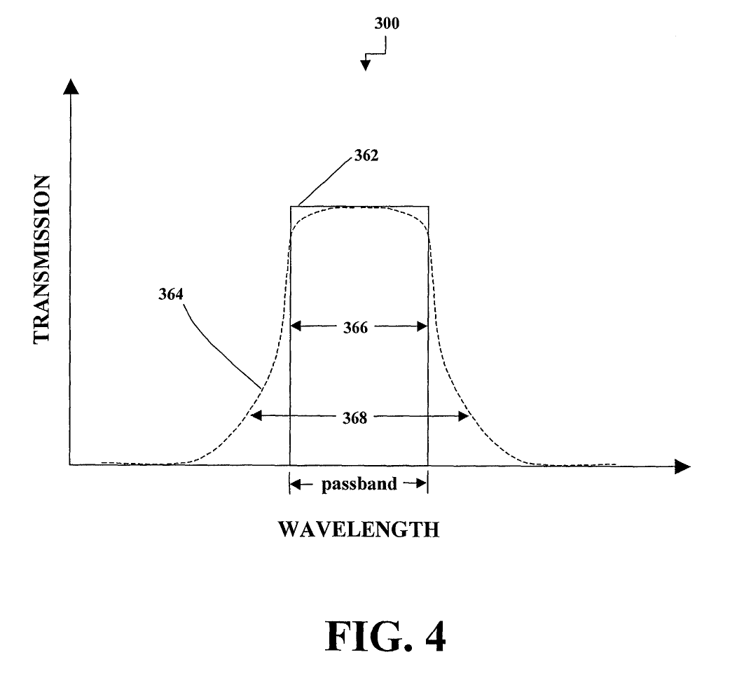

FIGS. 3 and 4 are a schematic view of the illustrative prism reflector 202 and its corresponding spectral response, respectively, according to the present invention. The prism reflector 202 is fabricated from an optical glass. The prism reflector 202 includes an entrance port 134 located at a distance a in front of entrance face 330. The prism reflector 202 also includes a first reflective surface 306, a second reflective surface 310 and an exit face 312 having an exit port 132. In this embodiment, the exit port 132 is coplanar with the entrance port 134.

In operation, a converging beam of light 322′ is incident on the entrance face 330 at area 134. An image 308 (minimum spot size) is generated on the first reflective surface 306 at position 308 by focusing the light on the first reflective surface 306. The optical passband 300 of the filter 200 is depicted by sharp transitions 366 in transmission as shown by the graph 362. The slope of the edges of the passband 368 decreases as the image 308 is defocused as depicted by the dotted line 364. A decreased slope can result in an increase in the crosstalk between channels of a WDM system. The input light 322′ exits the prism reflector 202 as exit beam 322.

The index normalized distance from the optical element 114 through the entrance face 330 to the first reflective surface 306 is the focal length of the optical element 114. In order for the WDM component wavelengths 116 to couple to the output waveguide 104, the index normalized distance from the first reflective surface 306 through the exit face 312 to the optical element 114 is also the focal length of the optical element 114. A first index normalized distance between the entrance port 134 and the image 308 is given by:

$$first index normalized dist . = \frac{a}{{n}_{a}} + \frac{c}{{n}_{c}} \qquad ( 1 )$$

where nₐ is the index of refraction in air and n_{c} is the index of refraction of the optical glass of the prism reflector 202. A second index normalized distance from the exit port 132 through the second reflective surface 310 to the image 308 is given by:

$$second index normalized dist . = \frac{a}{{n}_{c}} + \frac{c}{{n}_{c}} + \frac{b}{{n}_{c}} \qquad ( 2 )$$

Therefore, for the best coupling,

$$\frac{a}{{n}_{a}} + \frac{c}{{n}_{c}} = \frac{a}{{n}_{c}} + \frac{c}{{n}_{c}} + \frac{b}{{n}_{c}} \qquad ( 3 )$$

Assuming nₐ=1, equation (3) can be expressed as:

$$a = \frac{b}{{n}_{c} - 1} \qquad ( 4 )$$

For example, if b is 125 μm and n_{c} is 1.5, then a is 250 μm. It should be noted that the prism reflector 202 of FIG. 3 is not drawn to scale. If the first index normalized distance is not substantially equivalent to the second index normalized distance, the image 308 is defocused on the first reflective surface 306 or the coupling to the output waveguide 104 is lowered. Skilled artisans will appreciate that other geometries and other indices of refraction can be used in the prism reflector 202 without departing from the spirit and scope of the invention.

FIG. 5A depicts an alternative prism reflector 400. This structure 400 includes a prism 402 and an optical plate 404. The optical plate 404 is separated from the prism 402 by an air gap 420. FIG. 5B depicts another prism reflector 400′ according to the invention in which the optical plate 404 is positioned against one face of the prism 402. FIG. 5C depicts an optical module 400″ using a plurality of optical elements. The optical module 400″ includes two mirrors 422, 424 and an optical plate 436. For the embodiments depicted in FIGS. 5A to 5C, the indices of refraction and the thicknesses are selected to satisfy the requirement that the index normalized distances before and after the first reflective surface are equal.

FIG. 6A depicts a transmission grating 500 used as a spectrally dispersive element 120 of the present invention. Collimated light 510 incident on surface 514 is transmitted through the grating 500 and exits at the opposite surface 516. Internal reflective periodic structures 508 are separated from adjacent structures by a distance d. The grating 500 is oriented at an angle in the range of 20 to 70 degrees to the direction of propagation of an incident light beam 510. The output WDM component wavelengths 512 are dispersed in the Y-Z plane. Each WDM component wavelength 512 is diffracted at an angular orientation which varies according to its wavelength. For example, if the angle of incidence of beam 510 with respect to structure 508 is α and the angle of transmission of beam 512 with respect to structure 508 is α′, then:

d sin α+d sin α′=mλ (5)

where λ is the wavelength and m is an integer. In this example, the index of refraction is assumed to be 1. Thus, if m is 1, the angular dispersion dα′/dλ at α′=α is equal to 2/λtanα. Therefore, the angular dispersion in the 1600 nm wavelength range at α=45° is approximately 1/800 radian/nm.

FIG. 6B depicts a transmission grating 502 featuring a surface 523 having a comb-like structure. The individual surface elements 521 have a periodic spacing d′. Each surface element 521 includes a reflective surface 520. The collimated light 526 incident on the surface 528 of the grating 502 is transmitted through the grating 502 and diffracted into its WDM component wavelengths 512.

FIG. 6C depicts a reflection grating 504 used as a spectrally dispersive element 120 according to the invention. The grating includes reflection elements 536 disposed at periodic spacing d″. Light 538 incident as the grating 504 is reflected into its WDM component wavelengths 512.

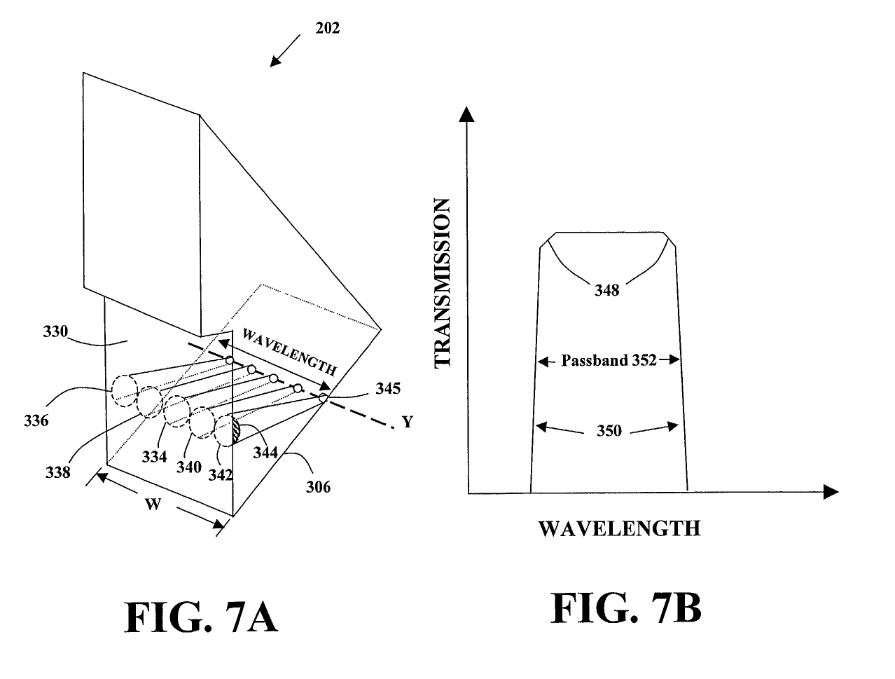

FIG. 7A is a perspective view of the prism reflector 202 of the illustrative optical bandpass filter 200. The physical width W of the surface 330 corresponds to the passband as depicted in FIG. 7B. The spectrally dispersive element 120 disperses the optical signal into a plurality of WDM component wavelengths imaged on the first reflective surface 306 along the Y-axis. The prism reflector 202 is designed such that WDM component wavelengths 334, 336, 338, and 340 are included in the passband. WDM component wavelength 342 is at one end of the passband and has an optical footprint that is not fully incident on surface 330 and thus some of its optical energy does not contribute to an image 345 at the first reflective surface 306. The lost energy from both sides of the surface 330 affects the spectral passband 352 by reducing the transmission in the regions 348. Because the images have a finite spot size at surface 306, the slope of the spectral transmission in regions 350 are also finite (i.e., not vertical). This slope decreases as the spot size at surface 306 increases.

For example, assuming the angular dispersion is 1/800 radian/nm and the focal length of the optical element is 4 cm, if each of the WDM component wavelengths 334, 336, 338, 340, and 342 has a focused diameter of approximately 10 μm on the first reflective surface 306, the wavelength change from out-of-band to in-band is less than 0.2 nm. In contrast, WDM systems with 50 GHz channel spacing have approximately a 0.4 nm separation between channels.

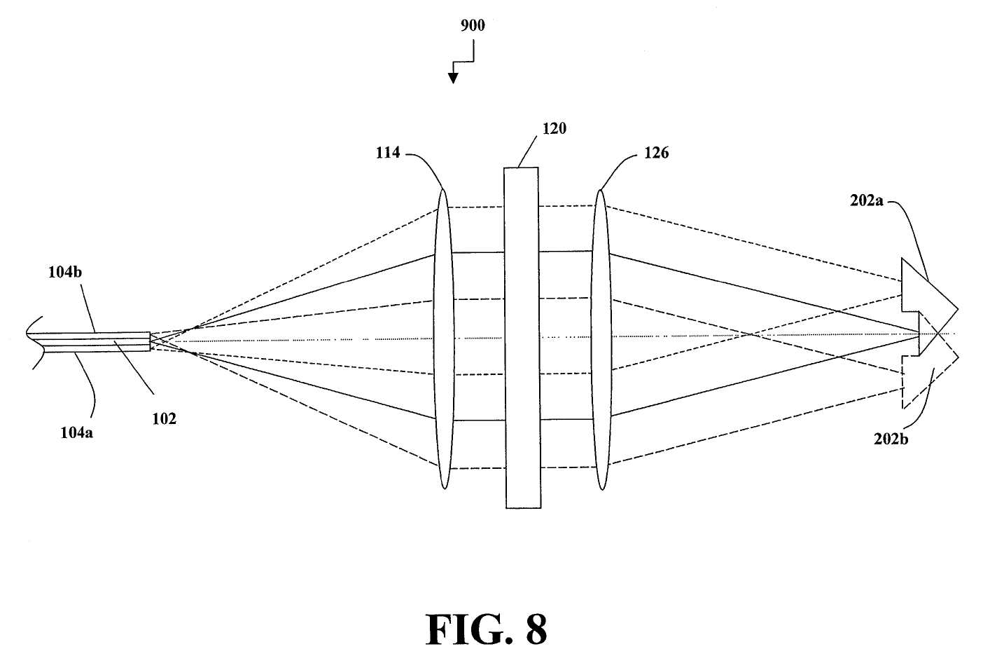

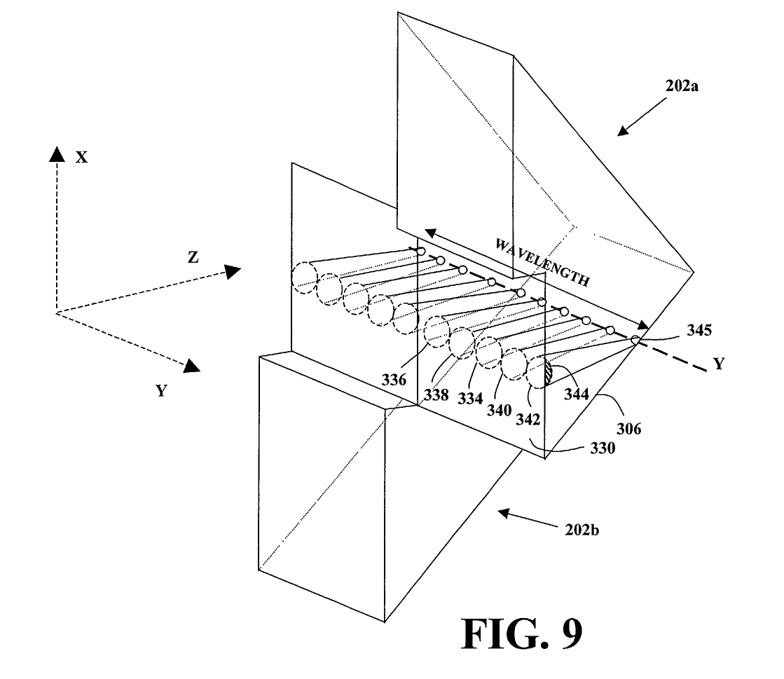

FIG. 8 depicts an optical bandpass filter 900 having two reflectors 202a and 202b. (It should be appreciated that any number of prism reflectors can be used without departing from the scope of the invention.) Input waveguide 102 is located between output waveguides 104a and 104b. WDM component wavelengths incident on prism reflector 202a are imaged at output waveguide 104a. WDM component wavelengths incident on the prism 202b are imaged at output waveguide 104b. FIG. 9 is a perspective view of the combination of the prism reflectors 202a and 202b of FIG. 8.

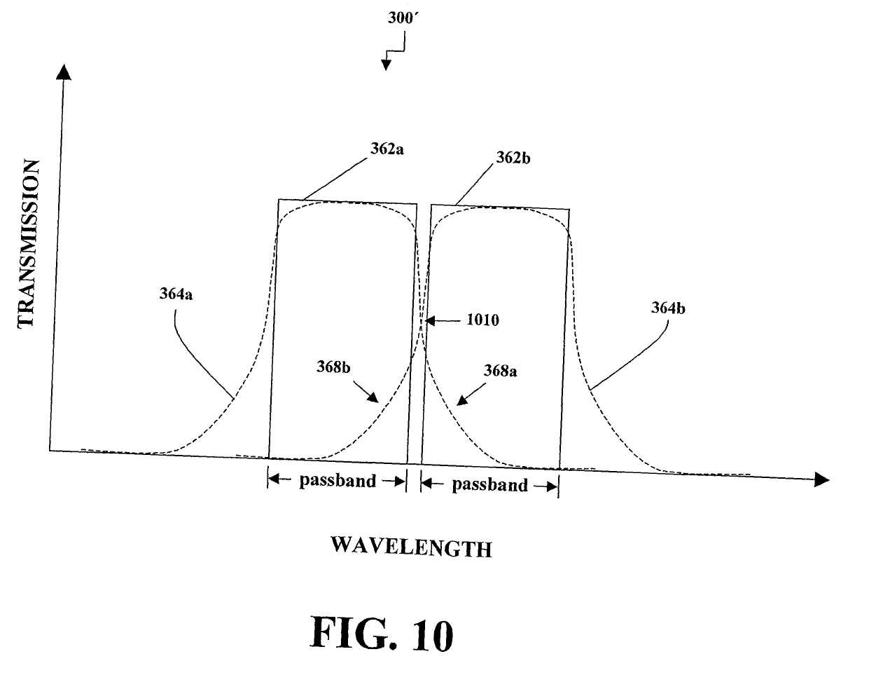

FIG. 10 is a graphical representation 300′ of the two spectral passbands 362a and 362b corresponding to the WDM component wavelengths of the two prism reflectors 202a and 202b of FIG. 9. The need to accurately focus WDM component wavelengths onto the first reflective surface 306 is demonstrated at the crossing point 1010. Moreover, inefficient cut-off characteristics 368a and 368b lead to undesirable crosstalk.

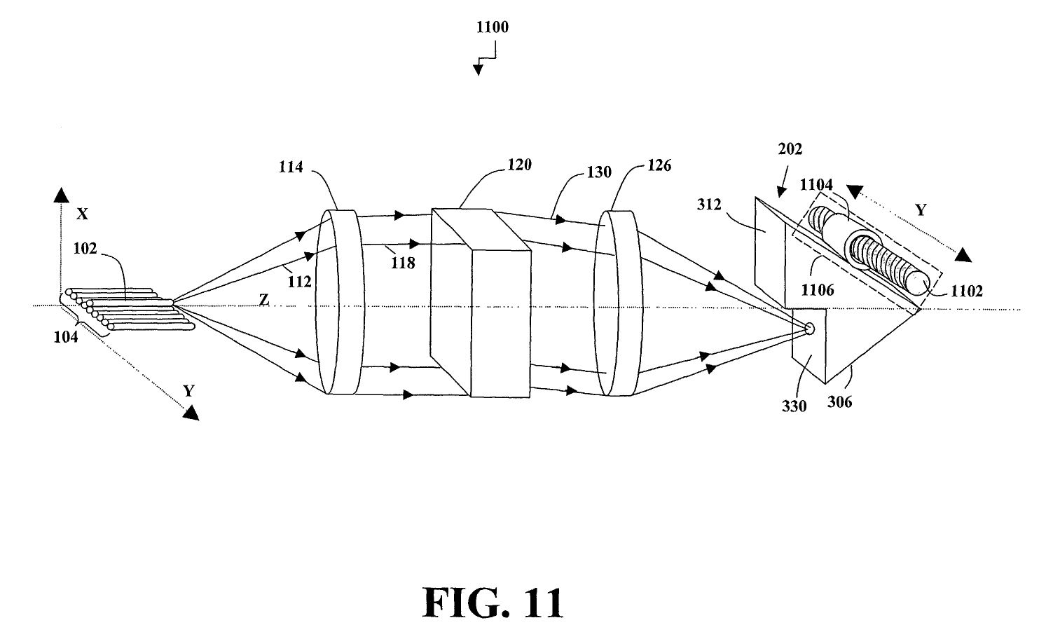

FIG. 11 illustrates an alternative configuration 1100 of the optical bandpass filter of the present invention. This embodiment includes an input waveguide 102, an optical element 114, a spectrally dispersive element 120, an optical element 126, and a prism reflector 202. The prism reflector 202 is attached to a translation mechanism 1106 that positions the prism reflector 202 at discrete locations along the Y-axis. Each discrete location corresponds to a desired passband. The translation mechanism 1106 can be a commercially available translation stage or device known to skilled artisans.

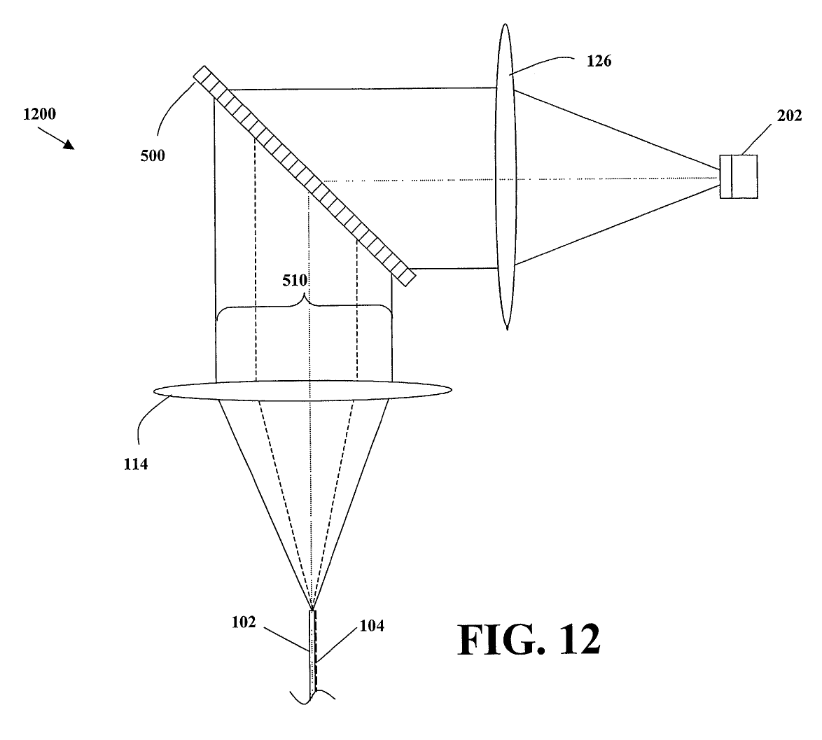

FIG. 12 illustrates an alternative configuration 1200 of the optical bandpass filter of the present invention as viewed from the X-direction. This embodiment includes an input waveguide 102, an output waveguide 104, an optical element 114, a transmission grating 500, an optical element 126, and a prism reflector 202. The transmission grating 500 is similar to the transmission grating 500 discussed with reference to FIG. 6A. The transmission grating 500 is oriented at about 45 degrees with respect to the direction of propagation of the collimated optical signal 510. Other spectrally dispersive elements can be used without departing from the scope of the invention.

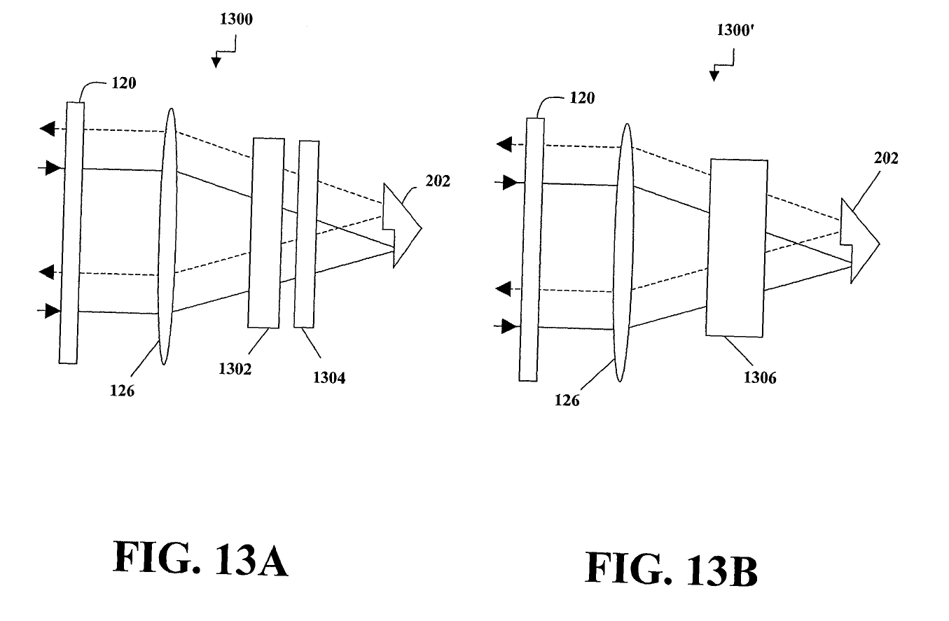

Referring to FIG. 13A, the input signal incident on the spectrally dispersive element 120 can have different efficiencies for polarization components defined on orthogonal axes. The efficiency of the spectrally dispersive element 120 can be affected by the polarization components of the input signal 112. For example, the spectrally dispersive element 120 can exhibit different optical losses for the two polarization components. Thus the performance of the filter 100 is dependent on the polarization of the light provided by the input fiber 102. If the instant polarization components are rotated by 90 degrees on their return pass to the spectrally dispersive element 120, the performance of the filter 100 is independent of the input polarization.

FIG. 13A illustrates an example of an optical bandpass filter 1300 for minimizing polarization dependent losses in the spectrally dispersive element 120. The embodiment includes a quarter-wave plate 1302 and a waveplate 1304. The waveplates 1302 and 1304 are disposed between the optical element 126 and the prism reflector 202.

Due to the total internal reflection of the prism reflector 202, there is an optical phase difference between the s-polarization and the p-polarization of the optical signal. The waveplate 1304 is designed such that it provides a reverse phase difference equivalent to one-half of the phase difference between the s-polarization and the p-polarization in the prism reflector 202. Since the light beams pass through the waveplate 1304 twice, the polarization effect of the prism reflector 202 on the optical signal is effectively canceled.

The quarter-wave plate 1302 is oriented such that its fast and slow axes are at 45 degrees with respect to the fast and slow axes of the waveplate 1304. Because the optical signal passes through the quarter-wave plate 1302 twice, it behaves as a half-wave plate with a 45-degree orientation. Therefore, each polarization component in the beam after first exiting the spectrally dispersive element 120 is rotated by 90 degrees on its return to the spectrally dispersive element 120. As a result, the polarization of the input beam does not affect the transmission of the bandpass filter 1300, even if the spectrally dispersive element 120 exhibits a polarization dependent loss.

FIG. 13B illustrates an example of an optical bandpass filter 1300′ for minimizing polarization dependent losses in the spectrally dispersive element 120. The embodiment includes a waveplate 1306 having the equivalent retardation characteristics of the combination of the waveplates 1302 and 1304 of FIG. 13A. The waveplate 1306 is disposed between the optical element 126 and the prism reflector 202.

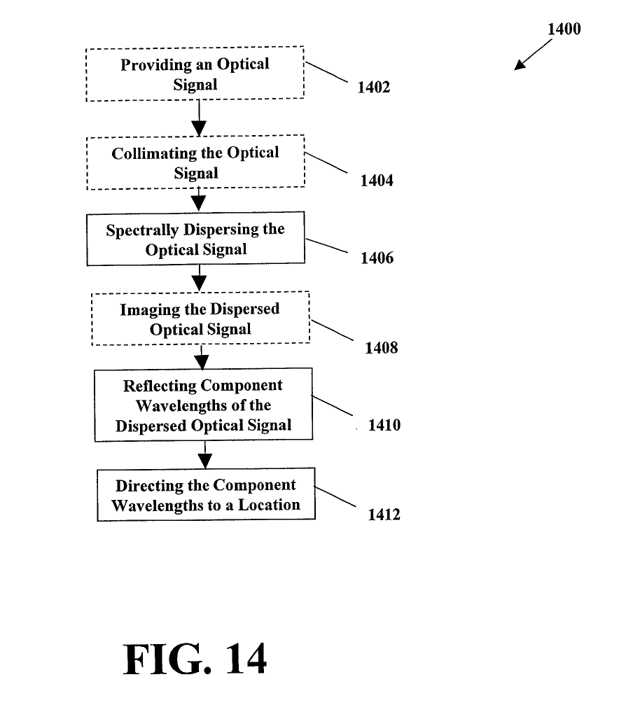

FIG. 14 is a flowchart 1400 that illustrates a method of filtering an optical signal having a plurality of WDM component wavelengths. Solid boxes indicate essential steps in the method and dashed boxes indicate optional steps. The method includes the steps of providing an optical signal having a plurality of WDM component wavelengths 1402, collimating the optical signal 1404, and spectrally dispersing the optical signal into its WDM component wavelengths 1406. The method also includes the steps of imaging the dispersed optical signal 1408, reflecting the WDM component wavelengths of the dispersed optical signal 1410, and directing the WDM component wavelengths to a location 1412. The step of directing the WDM component wavelengths 1412 can include imaging the WDM component wavelengths onto the endface of an output optical fiber. In one embodiment, the WDM component wavelengths are directed to multiple output optical fibers.

Having described and shown the preferred embodiments of the invention, it will now become apparent to one of skill in the art that other embodiments incorporating the concepts may be used and that many variations are possible which will still be within the scope and spirit of the claimed invention. These embodiments should not be limited to disclosed embodiments but rather should be limited only by the spirit and scope of the following claims.

What is claimed as new and secured by Letters Patent is:

1. A bandpass filter for filtering an optical signal having a plurality of WDM component wavelengths comprising:
a spectrally dispersive element adapted to receive said optical signal, said spectrally dispersive element providing a dispersed optical signal having a plurality of WDM component wavelengths; and
an optical module in optical communication with said spectrally dispersive element, said optical module comprising:
an entrance port;
a light concentration plane in optical communication with said entrance port, light concentration plane being optically separated from said entrance port by a first index normalized distance; and
an exit port in optical communication with said light concentration plane, said exit port being optically separated from said light concentration plane by a second index normalized distance,
wherein said first index normalized distance is substantially equivalent to said second index normalized distance and said optical module reflects at least two of said plurality of WDM component wavelengths to said spectrally dispersive element, said spectrally dispersive element directing said at least two of said plurality of WDM component wavelengths to a predetermined location.

2. The bandpass filter of claim 1 wherein said optical module comprises an optical delay element disposed between said light concentration plane and said exit port.

3. The bandpass filter of claim 1 wherein said light concentration plane comprises a first reflective surface.

4. The bandpass filter of claim 3 further comprising a second reflective surface disposed between said first reflective surface and said exit port.

5. The bandpass filter of claim 1 further comprising an input waveguide in optical communication with said spectrally dispersive element, said input waveguide adapted to provide said optical signal.

6. The bandpass filter of claim 1 further comprising an output waveguide in optical communication with said spectrally dispersive element, said output waveguide adapted to receive said at least two of said plurality of WDM component wavelengths of said dispersed optical signal at said predetermined location.

7. The bandpass filter of claim 1 further comprising an optical element in optical communication with said spectrally dispersive element, said optical element adapted to provide a collimated optical signal to said spectrally dispersive element.

8. The bandpass filter of claim 1 further comprising an optical element in optical communication with said spectrally dispersive element, said optical element generating a plurality of spectral images in response to said plurality of WDM component wavelengths of said dispersed optical signal.

9. The bandpass filter of claim 1 wherein said spectrally dispersive element comprises a grating.

10. The bandpass filter of claim 1 further comprising a plurality of optical modules in optical communication with said spectrally dispersive element, each of said plurality of optical modules reflecting at least two of said WDM component wavelengths of said dispersed optical signal through said spectrally dispersive element to a respective predetermined location.

11. The bandpass filter of claim 1 wherein said optical module comprises a prism.

12. The bandpass filter of claim 1 further comprising at least one waveplate disposed between said spectrally dispersive element and said optical module.

13. The bandpass filter of claim 12 wherein one of said at least one waveplate is a quarter-wave plate.

14. A bandpass filter for filtering an optical signal having a plurality of WDM component wavelengths, comprising:
a first optical element adapted to receive said optical signal and to generate a collimated optical signal;
a spectrally dispersive element in optical communication with said first optical element, said spectrally dispersive element providing a dispersed optical signal having a plurality of WDM component wavelengths;
a second optical element in optical communication with said spectrally dispersive element, said second optical element generating a spectral image in response to said WDM component wavelengths of said dispersed optical signal; and
a prism in optical communication with said spectrally dispersive element, said prism comprising:
an entrance port;
a light concentration plane in optical communication with said entrance port, said light concentration plane being optically separated from said entrance port by a first index normalized distance; and
an exit port in optical communication with said light concentration plane, said exit port being optically separated from said light concentration plane by a second index normalized distance,
wherein said first index normalized distance is substantially equivalent to said second index normalized distance and said optical module reflects at least two of said plurality of WDM component wavelengths to said spectrally dispersive element, said spectrally dispersive element directing said at least two of said plurality of WDM component wavelengths to a predetermined location.

15. The bandpass filter of claim 14 wherein said prism comprises an optical delay element disposed between said light concentration plane and said exit port.

16. The bandpass filter of claim 14 wherein said light concentration plane comprises a first reflective surface.

17. The bandpass filter of claim 16 further comprising a second reflective surface disposed between said first reflective surface and said exit port.

18. The bandpass filter of claim 14 further comprising an input waveguide in optical communication with said first optical element, said input waveguide adapted to provide said optical signal.

19. The bandpass filter of claim 14 further comprising an output waveguide in optical communication with said first optical element, said output waveguide adapted to receive at least two of said plurality of WDM component wavelengths of said dispersed optical signal at said predetermined location.

20. The bandpass filter of claim 14 wherein said spectrally dispersive element comprises a grating.

21. The bandpass filter of claim 14 further comprising a plurality of prisms in optical communication with said spectrally dispersive element, each of said plurality of prisms reflecting at least two of said WDM component wavelengths of said dispersed optical signal through said spectrally dispersive element to a respective predetermined location.

22. The bandpass filter of claim 14 further comprising at least one waveplate disposed between said spectrally dispersive element and said prism.

23. The bandpass filter of claim 22 wherein one of said at least one waveplate is a quarter-wave plate.

24. A bandpass filter for filtering an optical signal having a plurality of wavelength components, comprising:
a first optical element adapted to receive said optical signal and to generate a collimated optical signal;
an optical grating in optical communication with said first optical element, said optical grating providing a dispersed optical signal having a plurality of WDM component wavelengths;
a second optical element in optical communication with said optical grating, said second optical element generating a spectral image in response to said WDM component wavelengths of said dispersed optical signal; and
a plurality of prisms in optical communication with said optical grating, each of said plurality of prisms comprising:
an entrance port;
a light concentration plane in optical communication with said entrance port, said light concentration plane being optically separated from said entrance port by a first index normalized distance; and
an exit port in optical communication with said light concentration plane, said exit port being optically separated from said light concentration plane by a second index normalized distance,
wherein said first index normalized distance is substantially equivalent to said second index normalized distance, each of said plurality of prisms reflecting at least two of said WDM component wavelengths of said dispersed optical signal to said optical grating, said optical grating directing said at least two of said plurality of WDM component wavelengths to a predetermined location.

25. The bandpass filter of claim 24 wherein each of said plurality of prisms comprises an optical delay element disposed between said light concentration plane and said exit port.

26. The bandpass filter of claim 24 wherein said light concentration plane comprises a first reflective surface.

27. The bandpass filter of claim 26 further comprising a second reflective surface disposed between said first reflective surface and said exit port.

28. The bandpass filter of claim 24 further comprising an input waveguide in optical communication with said first optical element, said input waveguide adapted to provide said optical signal.

29. The bandpass filter of claim 24 further comprising a plurality of output waveguides in optical communication with said first optical element, said output waveguide adapted to receive said WDM component wavelengths of said dispersed optical signal at said respective predetermined locations.

30. The bandpass filter of claim 24 further comprising at least one waveplate disposed between said optical grating and said plurality of prisms.

31. The bandpass filter of claim 30 wherein one of said at least one waveplate is a quarter-wave plate.

32. A method of filtering an optical signal having a plurality of WDM component wavelengths, comprising:
spatially dispersing said optical signal to generate a dispersed optical signal having a plurality of WDM component wavelengths;
reflecting at least two of said plurality of WDM component wavelengths such that a first index normalized distance between a source of said optical signal and a light concentration plane is substantially equivalent to a second index normalized distance between said light concentration plane and a predetermined location; and
directing said at least two of said plurality of WDM component wavelengths to a predetermined location.

33. The method of claim 32 wherein said predetermined location is substantially adjacent to said source.

34. The method of claim 32 further comprising providing said optical signal.

35. The method of claim 32 further comprising reflecting at least two of said plurality of WDM component wavelengths of said dispersed optical signal to a plurality of respective predetermined locations.
